(19) United States
(12) Patent Application Publication
(10) Pub. No.: US 2007/0058118 A1
(43) Pub. Date: Mar. 15, 2007

(54) Compensation film for flexible displays

(76) Inventors: Peter Albert Cirkel, Eindhoven (NL); Petrus Cornelis Paulus Bouten, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/557,657

(22) PCT Filed: May 19, 2004
(86) PCT No.: PCT/IB04/50752

§ 371 Date: Nov. 21, 2005

(30) Foreign Application Priority Data
May 27, 2003 (EP) 03101526.6

(51) Int. Cl. G02F 1/1335

(52) U.S. Cl. 349/117

(57) ABSTRACT

The present invention provides for improved image quality in bendable liquid crystal displays (400). In such displays the liquid crystal layer (401) is contained in a cell gap having a thickness which decreases when the display is bent. For displays based on swithcable retardation, such as TN (Twisted Nematic) or STN (Super Twisted Nematic) displays, this has as a consequence that the cell retardation value decreases, such that optical properties as colour, contrast and viewing angle become less good. The inventions therefore proposes to compensate for this effect with a compensating film (407) or coating of having a retardation which changes as a function of stress induces in the layer when the display is bent and thereby compensates the retardation changes of the liquid crystal (401) such that the total retardation (cell+compensator) stays constant

### FIELD OF THE INVENTION

The present invention is directed towards improving the picture quality of flexible liquid crystal displays.

### TECHNOLOGICAL BACKGROUND

Liquid crystal displays (LCDs) are normally rigidly flat due to the rigid nature of their substrate material, for example glass. However, flexible LCDs have recently been provided in which the glass substrates have been substituted for thin plastic composite films. There are many settings in which the use of flexible displays would be advantageous, e.g. for rollable laptops and wearable electronics.

Some liquid crystal displays, such as TN (Twisted Nematic) or STN (Super Twisted Nematic), are based on switchable retardation. Retardation is basically the ability of materials to phase shift light and is provided for by materials having different refractive indices in different directions. LCDs based on swithcable retardation generally comprise a liquid crystal layer sandwiched between various substrates, retarders and polarisers in a carefully chosen set-up, in order to provide for the required front of screen performance (such as contrast, brightness, and colour). The front of screen performance for such displays is critically dependent on accurate cell retardation, and an optimal value for the cell retardation is typically determined by computer modelling when designing the display. The desired cell retardation can be obtained by choosing the right combination of liquid crystal mixture and cell gap thickness. However, since these displays have a finite thickness, curving or bending the display will compress the cell gap and thus reduce the thickness of the liquid crystal layer. Any such cell gap variation will affect the retardation, δ, which is linearly dependent on the thickness of the cell gap, d:
δ=d(nₓ−n_{y})

where nₓ and n_{y} is the refractive index of the liquid crystal along the x- and y-axis, respectively, and where the x- and y-axes span the lateral plane of the display.

Cell gap changes induced by bending the display thus change the retardation effect of the liquid crystal layer and, as a consequence thereof affect the front of screen performance which thereby is moved out of its optimum. Therefore, known flexible LCDs based on switchable retardation exhibit reduced front of screen performance when bent In other words, such flexible (or bendable) displays are associated with the problem of picture quality degradation when bent

### SUMMARY OF THE INVENTION

It is therefore an object of the present invention to alleviate the above problem relating to reduced front of screen performance for bent displays.

It has thus been observed that bending of a flexible LCD changes the switching characteristics of the display, and that this effect is due to the finite thickness of the display which causes bending to create a pressure on the spacers between the substrates and thus to decrease the cell gap. Calculations show that this pressure affects the cell gap due to deformations of the spacers as well as deformations of the substrates. It has furthermore been established that the pressure on the spacers depends on the local radius of curvature of the display, R, such that the cell gap thickness changes linearly with 1/R². In practice, measurements show that the change of the cell gap thickness, and thus of the retardation, has an essentially linear dependence on 1/R.

Plastic materials typically change their optical retardation properties when deformed, due to reorientation of polymer chains. This opto-elastic effect is well known and described in literature. In fact, there are special films and coatings in which this opto-elastic effect is especially pronounced. In these films the retardation, δ, changes with the strain, εₓ and ε_{y}, as follows:
δ=tK(εₖ−ε_{y})

where t is the film thickness and K is the strain optical coefficient, a material parameter of the film.

As a basis for the present invention, the inventors have realised that this opto-elastic effect can be exploited in order to reduce or even cancel the curve radius dependence of liquid crystal displays. This can be achieved by applying a compensating layer or film on the display, given that the retardation of the film depends on the curve radius in a counteracting manner as compared to the liquid crystal layer. Depending on the sign of the strain-optical coefficient (K), the compensation film can be applied on either the front side or the backside of the liquid crystal layer. Of course, more than one compensating film or layer can be applied, for example one film on each side of the liquid crystal layer.

In general, if a compensation film is applied on the face side of a liquid crystal cell in a display, bending the display in a convex shape will induce a tensile strain on the film. For a fully elastic film bending the display will induce a strain (εₓ) which is inversely proportional to the bending radius, R:
εₓ=r/R

where r is the distance from the middle of the compensation film to the neutral plane of the bent cell. The neutral plane is the plane in the cell which is neither stretched nor compressed when bending the cell; in a symmetrical cell the neutral plane upon pure bending is located in the middle of the cell gap. The retardation of such a compensation film applied on the face side of a curved display element therefore increases linearly with the radius of curvature, and can thus be used to compensate for the decreased retardation of the compressed liquid crystal layer. The correct compensation film/coating can be provided by properly choosing the material constant K, the film thickness t, the substrate thickness and the thickness of any additional films in between the correction film and the display cell. The retardation of the correction film can be calculated by combining formula 1 and 2:
δ=tK(r/R)

According to one aspect of the present invention, a flexible liquid crystal display device is provided which is bendable such that a bending radius is defined. The inventive display device comprises:
a first and a second substrate layer,
a liquid crystal layer arranged between said substrate layers and having a retardation effect which changes as a function of said curve radius; and
at least one compensation layer, said compensation layer having a retardation effect which changes as a function of said curve radius so as to counteract said changes in retardation effect of the liquid crystal layer within a certain range of curve radii. The inventive display thus provides for improved bend characteristics in regard to the front of screen performance.

According to one embodiment, the compensating layer is provided as a separate layer in addition to the substrates, retarders, polarisers etc. of prior art displays. This design is advantageous in that prior art designs are easily and cost effectively modified so as to provide the advantages of the present invention.

Using dissimilar substrates, i.e. substrates having different retardation properties, results in a contribution to the retardation upon bending. Thus, instead of applying an additional retardation compensation layer, it is also possible to design the substrates, or any other layer in the display, so as to exhibit the desired counteracting retardation changes upon bending the display. The strain-optical coefficient of conventional substrates is however, as stated previously, far too low to have any significant effect on the total curve radius dependence of the retardation.

Thus, according to another embodiment the compensation layer is constituted by one of said substrate layers. This embodiment provides for a more compact design, and reduces the total number of layers in the display and thus also simplifies the manufacturing process.

According to still one embodiment, the display device further comprises a face side polariser on a face side of said liquid crystal layer and a backside polariser on a backside of said liquid crystal layer and the compensating layer is arranged between said polarisers. For many transmissive display types this is necessary, since the compensation needs to be carried out on the polarised light In case the display is a reflective display, the compensating layer is for the same reason arranged between a front side polariser and a backside mirror.

According to another embodiment, the compensating film has a non-zero retarding effect for every possible bend radii, the compensating film thus functioning also as a retarder. For display designs based on retarder compositions, for example for the provision of colour displays, this embodiment facilitates more compact display designs. Choosing a suitable material, in regard to K value as well as fundamental retardation effect, the combination of a retarding and compensating layer is readily provided for.

Depending on the application, the compensation film can be used to correct for the cell gap variation at a given radius of curvature or in a given curvature range.

The film conventionally used as substrates and retarders etc. in flexible display manufacturing also has a finite strain-optical coefficient For symmetric cells the contribution of the films can be neglected, whereas for non-symmetric cells the contributions might be taken into account However, the strain-optical coefficient of prior art materials are far too low to have any significant effect on the total retardation changes upon bending the display.

The preferred K values depend on various factors, like the thickness of the stress-optical layer and its distance from the neutral line of the entire display stack. However, for most applications it is only meaningful to compensate for retardation differences larger than approximately 1 nm. Furthermore, the film thickness will generally not be more than 200 micron and the distance between the compensation layer and neutral line will be less than 200 micron. Under these circumstances, the K value should in be higher than 0.001 which is substantially higher than for conventional retarders. Practically there is no upper value on K, because it is always possible to use a thinner layer or a layer which is closer to the neutral line.

In order to provide for the dynamic retardation compensation as a function of the curvature radius, it is also possible to move the neutral plane. The neutral plane can be moved, and the display thus made asymmetrical, by the application of an additional layer or film, which might very well be optically passive. Thus, according to one embodiment an optically passive layer is added having a flexural/bending resistance chosen so as to provide for accurate compensation of the compensating layer. The contribution from the various layers of the display to the final retardation can thus be chosen depending on the thickness of the additional layer.

Of course, a number of the above measurements can be combined, the common denominator being that the resulting curve radius depending retardation compensation counteracts the curve radius dependence of the liquid crystal layer retardation.

### BRIEF DESCRIPTION OF THE DRAWINGS

Various embodiments of the present invention will now be described with reference to the accompanying exemplifying drawings, on which:

FIG. 1 schematically shows an inventive display having a compensation coating.

FIG. 2 schematically shows a bent inventive display having a compensation coating.

FIG. 3 illustrates different layers of an inventive FSTN display.

FIGS. 4-7 schematically illustrate cross sections of different embodiments of the inventive display device.

FIG. 8 is a curve diagram illustrating the retardation change upon bending of the display, calculated for:

the liquid crystal layer change upon bending (805);

the bent compensation film (804);

A pre-stressed compensation film (803); and

Resulting curve with (801) and without (802) prestress.

FIG. 9 is a diagram presenting measured retardation for a compensation coating on a liquid crystal cell.

FIG. 10 is a diagram presenting the cell gap change, determined from the switching characteristics of a display.

### DETAILED DESCRIPTION OF THIS INVENTION

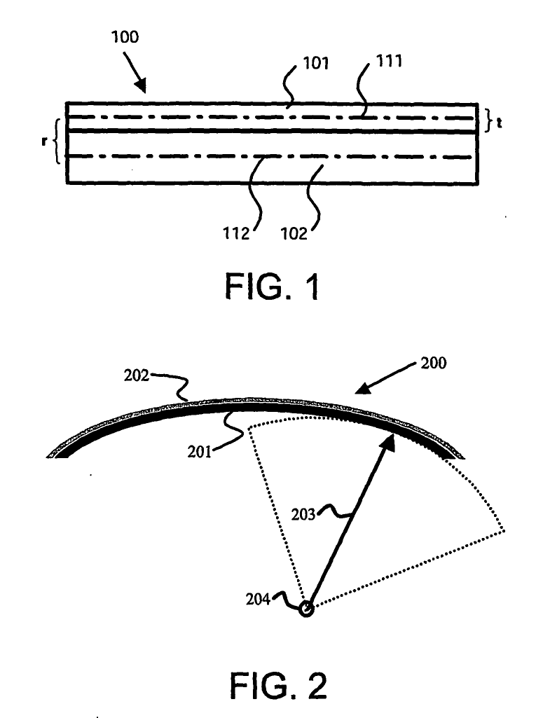

FIG. 1 schematically illustrates a compensated display cell 100 consisting of a display cell 102, which comprises two substrates and an intermediate liquid crystal layer, and an additional coating 101, which provides counteracting retardation changes as compared to the liquid crystal layer when bending the display. Retarders and polariser needed for making up a complete display stack are left out for reasons of clarity. Line 112 illustrates the neutral plane of the display cell, and line 111 illustrates the centre of the additional coating. Also illustrated in the figure is the thickness of the coating 111, t, and the distance, r, between the neutral plane 112 and the centre of the coating 111.

In FIG. 2, a bent compensated display cell 200 is illustrated. Similar to FIG. 1, the display comprises a display cell 201 and a coating 202. Furthermore, a local curve radius 203 and an axle or pivot point 204 around which the display is locally bent are illustrated. As is the case for the display illustrated in FIG. 2, the display may be unevenly bent, and will then have a plurality or even an infinite number of pivot points.

The compensating layer can be applied in a liquid phase and subsequently cured. One possible material for this purpose is available from Vishay Measurements Group under the trade name PL-2 liquid. Alternatively, the compensating layer can be in the form of a foil, laminated into the display device. One possible material for this purpose is available from Vishay Measurements Group under the trade name PS-3 Sheet. The retardation compensating effect of such a foil can be increased by means of pre-stressing the foil before applying it to the display device. Choosing the level of pre-stress in the compensating layer is thus yet another way of customising the retardation compensation, in addition to choosing the material characteristics and the film thickness.

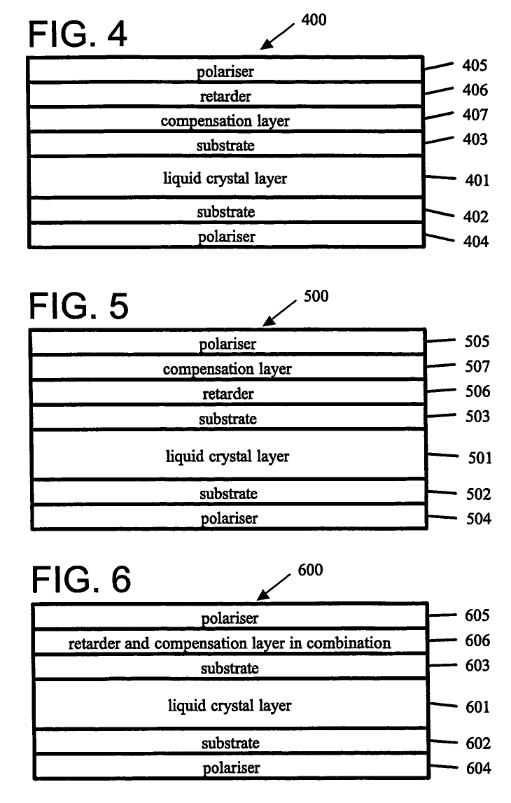

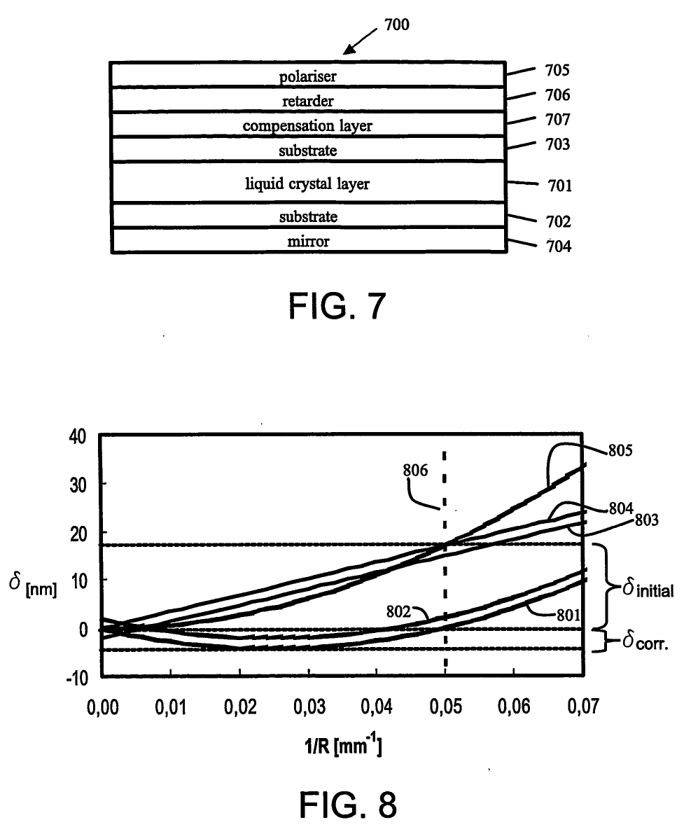

In FIG. 4 a cross section of an inventive display 400 is schematically illustrated in further detail. The display 400 comprises a liquid crystal layer 401 encapsulated by substrates 402, 403. The display cell is laminated between a face side polariser 405 and a backside polariser 404. A retarder 406 and a compensation layer 407 are deposited between the face side polariser and the substrate 403. The compensation layer is designed so as to compensate for retardations changes in the liquid crystal layer upon bending of the display. It is also possible for the compensation layer to have a different position among the various layers of the display, but it must be arranged between the face side polariser and the backside polariser, in transmissive displays, and between the face side polariser and the backside mirror, in reflective displays. For example, as is schematically illustrated in FIG. 5, the compensating layer 507 might be arranged outside the retarder 506. Except for this difference, the display illustrated in FIG. 5 is similar to the one illustrate in FIG. 4. In FIG. 6 another inventive display 600 is schematically illustrated. Similar to the display illustrated in FIG. 4, display 600 comprises a liquid crystal layer 601, substrates 602, 603, polarisers 604, 605 and a retarder. However, according to this embodiment the material in the retarder is chosen so as to function also as a bend compensating layer. In FIG. 7 still another inventive display 700 is shown. This display is similar to display 400, except for the backside polariser 404 which is exchanged for a mirror 704. The display 700 is thus a reflective display, as opposed to the above displays which are transmissive.

Compensating a display according to the invention will always partly be a matter of choosing between contrast, brightness and colour. These effects can be evaluated using computer modelling. As a simple illustration, the following is an example in which the cell retardation in the off state is changed as little as possible when the display is curved. In the example given below, correction in a certain range (R>20 mm) is used whereas bending from concave to convex is not treated.

### EXAMPLE

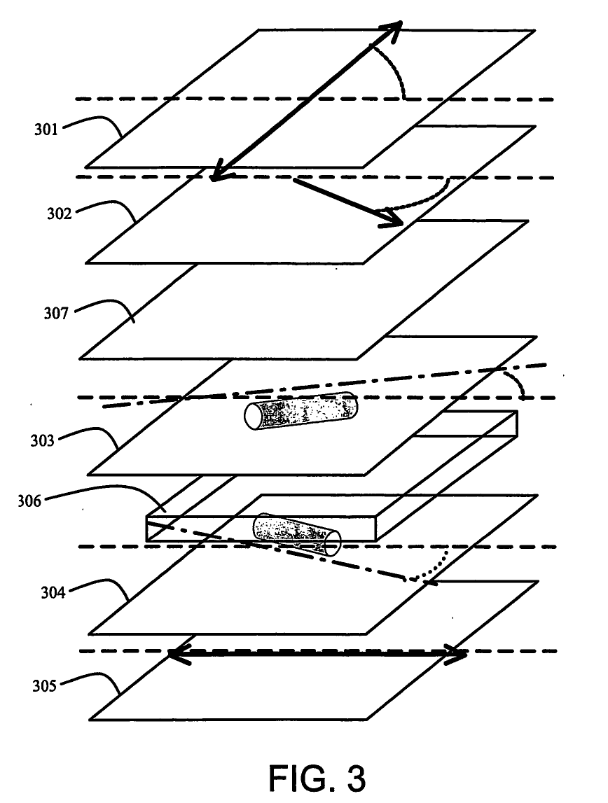

An FSTN (Foil compensated Super Twisted Nematic) display assembled as illustrated in FIG. 3 was provided. The display thus comprised an upper substrate 303 and a lower substrate 304, which were formed from 120 micron thick polycarbonate films with barrier coatings (e.g. DT120, available from Teijin) and lithographic rib spacers placed in a certain configuration between the substrates. A layer of liquid crystal 306 was deposited between the substrates, and the substrates were sandwiched between an upper polariser 301 and a lower polariser 305. Furthermore, a retarder 302 and subsequently a compensating layer 307 were arranged between the upper substrate and the upper polariser.

Calculated measurements made on how the retardation changed as a function of the curve radius is shown in FIG. 8, where the curve radius is given along the x-axis and the corresponding retardation for the display and various layers thereof is given along the y-axis. For example, curve 805 gives the retardation change of the liquid crystal layer for an uncompensated display. For reasons of clarity, this curve is however inverted (the corresponding δ-values are actually negative).

As stated above, it has been established that the pressure on the cell gap spacers depends on the local radius of curvature of the display, R, such that the cell gap thickness changes linearly with 1/R². In practice, measurements show that the change of the cell gap thickness, and thus of the retardation, has an essentially linear dependence on 1/R, see FIG. 10.

When the display was flat, the cell gap was 4.8 micron and the cell retardation was 812 nm (i.e. δ=0 nm). When the display was bent to a diameter of 20 mm (i.e. 1/R=0.05 mm⁻¹), the cell gap decreased with 100 nm and the cell retardation decreased about 17 nm (i.e. δ=−17 nm).

To compensate for this change of retardation, a coating 307 of appropriate thickness (132 μm) and strain optical coefficient (K=0.02, available from Vishay Measurements Group under the trade name PL-2 liquid) was applied on top of the cell The coating was applied as a liquid and was subsequently cured. The retardation of the applied coating is given by line 804 in FIG. 8. Alternatively, a pre-stressed foil (available from Vishay Measurements Group under the trade name PS-3 sheet) could be applied, providing the retardation characteristics given by line 803. In a pre-stressed foil, the actual stress is of course the sum of the pre-stress and the stress resulting from bending the foil.

Calculations for the resulting retardation changes in the display with an ordinary and a pre-stressed coating are given by lines 802 and 801, respectively. As can be seen, the application of an appropriate pre-stress in the compensation layer leads to a shift of the compensated curve in such a way that the maximum difference δ_{corrected} in the region of interest (for instance R>20 mm) is minimal In the present example (curve 802 in FIG. 8), δ_{corrected}=0.125 δᵢₙᵢₜᵢₐₗ.

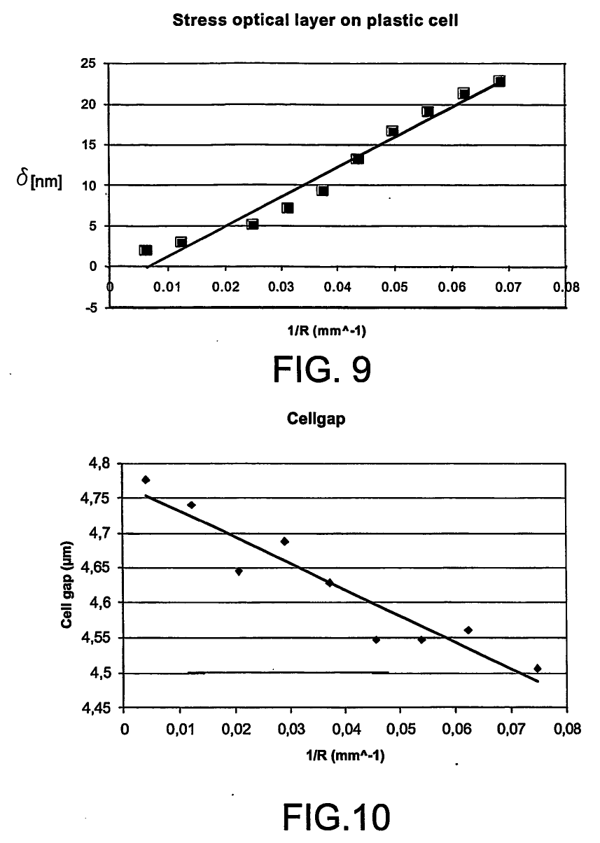

FIG. 9 shows actual measurements on the compensation effect of the non pre-stressed coating.

In the present example it is assumed that the position of the neutral line is not shifted due to the application of the coating. In practical situations both cell gap change and the position of the neutral line is affected by the application of the layer. This may lead to (slight) changes in the actual layer.

In essence, the present inventions provides for improves image quality in bendable liquid crystal displays. In such displays the liquid crystal layer is contained in a cell gap having a thickness which decreases when the display is bent. For displays based on swithcable retardation, such as TN (Twisted Nematic) or STN (Super Twisted Nematic) displays, this has as a consequence that the cell retardation value decreases, such that optical properties as colour, contrast and viewing angle become less good. The inventions therefore proposes to compensate for this effect with a compensating film or coating of having a retardation which changes as a function of stress induces in the layer when the display is bent and thereby compensates the retardation changes of the liquid crystal such that the total retardation (cell+compensator) stays constant

1. A flexible liquid crystal display device, which is bendable such that a bending radius defined, said display device comprising:
a first and a second substrate layer;
a liquid crystal layer arranged between said substrate layers and having a retardation effect which changes as a function of said curve radius; and
at least one compensation layer, said compensation layer having a retardation effect which changes as a function of said curve radius so as to counteract said changes in retardation effect of the liquid crystal layer within a certain range of curve radii.

2. A flexible liquid crystal display device according to claim 1, wherein said compensation layer provided as a separate layer.

3. A flexible liquid crystal display device according to claim 1, wherein said compensation layer constituted by a material having a stress-optical coefficient absolute value exceeding 0.001.

4. A flexible liquid crystal display device according to claim 1, wherein said compensation layer is constituted by a material having a stress-optical coefficient absolute value exceeding 0.01.

5. A flexible liquid crystal display device according to claim 1, wherein said compensation layer is constituted by one of said substrate layers.

6. A flexible liquid crystal display device according to claim 1, further comprising a face side polariser on a face side of said liquid crystal layer and a backside polariser on a backside of said liquid crystal layer and wherein said compensating layer arranged between said polarisers.

7. A flexible liquid crystal display device according to claim 1, wherein the display is a reflective display and the compensating layer is arranged between a front side polariser and a backside mirror.

8. A flexible liquid crystal display device according to claim 1, wherein the compensating film has a non-zero retarding effect for every possible bend radii, the compensating film thus functioning also as a retarder.

9. A flexible liquid crystal display device according to claim 1, further comprising an optically passive layer
having a flexural/bending resistance chosen so as to provide for accurate compensation of the compensating layer.
